(19) United States
(12) Patent Application Publication
(10) Pub. No.: US 2005/0228762 A1
(43) Pub. Date: Oct. 13, 2005

(54) System and method for on demand workforce framework

(75) Inventors: Daniel F. D'Elena, West Milford, NJ (US); Anne Marie Lake, New York, NY (US); Anthony Edward Martinez, St. Augustine, FL (US); Ronald James Salpietra, Huntersville, NC (US)

Correspondence Address: IBM CORPORATION- AUSTIN (JVL);C/O VAN LEEUWEN & VAN LEEUWEN, PO BOX 90609, AUSTIN, TX, 78709-0609, US

(73) Assignee: International Business Machines Corporation, Armonk, NY (US)

(21) Appl. No.: 10/822,272

(22) Filed: Apr. 8, 2004

(51) Int. Cl. G06F 17/30

(52) U.S. Cl. 706/1

(57) ABSTRACT

A system and method for an on demand workforce framework is presented. A profession-specific framework includes core skills, dimension skills, and functional skills which measures a user's capabilities within an organization. A framework generator uses business objectives and market conditions to identify particular skills and corresponding progression requirements for each of the organization's professions. The organization uses a profession-specific framework to evaluate and rank users that correspond to the profession. In addition, each user receives an overall ranking that is based upon the user's individual skill rankings. In one embodiment, other frameworks may be generated, such as a business model-specific framework or a business function-specific framework.

### BACKGROUND OF THE INVENTION

1. Technical Field

The present invention relates in general to a system and method for an on-demand workforce framework. More particularly, the present invention relates to a system and method for measuring responsive, variable, focused, and resilient characteristics of a profession and identifying improvement areas corresponding to a particular individual.

2. Description of the Related Art

Market conditions constantly evolve, and, in order to stay competitive, an organization is required to adapt to the evolving market conditions. One aspect of adapting to evolving market conditions is for an organization to adapt its structures and processes. For example, a small business may have identified the expansion of online consumer purchases, and may have improved its website in order to attract online customers. In this example, the small business may sell their products to customers worldwide due to its recognition of the changing market conditions. If the small business had not recognized the changing market conditions, the small business may be limited to selling its products to local customers.

A second aspect of adapting to evolving market conditions is that an organization is required to adapt its workforce. The organization's workforce should be able to exhibit responsive, variable, focused, and resilient characteristics of an on-demand workforce. A responsive workforce includes market driven skill development strategies that are tuned to having the right people with the right skills, in the right place at the right time. A variable workforce is one that is “fluid” and adapts to changing business market needs across a worldwide corporation. A focused workforce is experienced, able to work in close teams, and has individual skills that are tightly aligned to target markets. A resilient workforce receives “just-in-time” training through precise knowledge of their capabilities.

A challenge found, however, in establishing an on-demand workforce is the ability to measure a workforce's responsive, variable, focused, and resilient characteristics. A workforce includes employees that are responsible for particular job functions and the job functions may require different skill sets that change based upon market conditions. An organization, however, may also require foundational skills from each employee that the organization deems important. For example, an organization may require each employee to have adequate “relationship” skills because the organization believes that by each employee having good relationship skills, employees work well with each other when they are placed in teams.

What is needed, therefore, is a system and method for creating a framework that provides a business with the ability to dynamically measure a workforce's capabilities and develop the skills of the workforce to respond to changing market needs.

### SUMMARY

It has been discovered that the aforementioned challenges are resolved by using a profession-specific framework that includes core skills, dimension skills, and functional skills to measure an employee's capabilities within an organization. A framework generator uses business objectives and market conditions to identify particular skills and corresponding progression requirements for each of the organization's professions. The organization uses the framework to evaluate and rank employees that correspond to their particular profession. In addition, each employee receives an overall ranking that is based upon the employee's individual skill rankings. In one embodiment, other frameworks may be generated, such as a business model-specific framework or a business function-specific framework, for use in evaluating employees.

A framework generator aligns employee career development with an organization's business objectives. It enables the development of a fluid, on-demand workforce that quickly and decisively responds to changing market conditions. At the same time, the framework generator provides a stable direction to employees by establishing core skill guidelines for nurturing a successful career. The framework generator stratifies and describes a unique set of skills that an employee requires in order to advance in his career. Additionally, the framework generator defines different purposes and relationships of these stratified skill sets so an employee understands when, why, and how to develop each skill to best maximize his personal development and his professional career opportunities within an organization.

An organization uses market conditions to drive its business objectives. The organization may choose not to respond to minor fluctuations in the market conditions to significantly alter its business objectives. Rather, the organization may monitor trends corresponding to the market conditions and adapt its business objectives to the changing market trends. For example, an organization may identify a new technology trend and choose to enter in to a particular market niche corresponding to the market trend. The framework generator receives the organization's business objectives, and uses the business objectives to define dimension skills, functional skills, and progression requirements. Dimensional skills are skills that are aligned with a particular profession, such as an Information Technology (IT) architect or a consultant. Functional skills are skills that focus on a fine level of specialization within an industry, such as “oracle programming” in the IT industry.

An organization uses progression requirements to rank an employee based upon his capabilities that correspond to particular dimensional skills and core skills. Core skills are generalized skills that are required from each employee in order to support an organization's business objectives. For example, “relationship” may be a core skill that measures an employee's ability to communicate with other employees. In one embodiment, an organization may use the business objectives and market conditions to drive core skills in a broader, long-term sense.

The framework generator includes a profession-specific framework generator that generates a framework for a particular profession (i.e. IT architect). In one embodiment, the framework generator may include a business function-specific framework generator to generate frameworks that are specific to a business function, such as “package enablement.” In this example, an applications programmer and a salesperson that work with package enablement may be evaluated using a similar framework.

The profession-specific framework generator retrieves core skills and generates a core skills module. It then retrieves dimension skills that correspond to a particular profession, and generates a dimension skills module. Then, the profession-specific framework generator retrieves functional skills and generates a functional skills module. Finally, the profession-specific framework generator retrieves progression requirements that correspond to the retrieved core skills and the retrieved dimension skills, and includes the progression requirements, the core skills module, the dimension skills module, and the functional skills module in a profession-specific framework.

The profession-specific framework retrieves employee capabilities that corresponds to an employee, and compares the employee capabilities with the progression requirements. The profession-specific framework ranks the employee for each core skill and dimension skill. Once the employee is ranked for each skill, the employee receives an overall ranking based upon the employee's individual skill rankings. Using the employee's skill rankings, he is able to identify particular areas in which to focus in order to advance in his career.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing a framework generator generating a profession-specific framework that is based upon market conditions and business objectives;

FIG. 2 is a framework diagram that shows skills that are divided into three modules;

FIG. 3 is a diagram showing a profession-specific framework's modularity;

FIG. 4 is a diagram showing skill rankings for a particular user;

FIG. 5 is a flowchart showing steps taken in creating a profession-specific framework based upon skill sets and progression requirements;

FIG. 6 is a flowchart showing steps taken in ranking a user using a profession-specific framework; and

FIG. 7 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

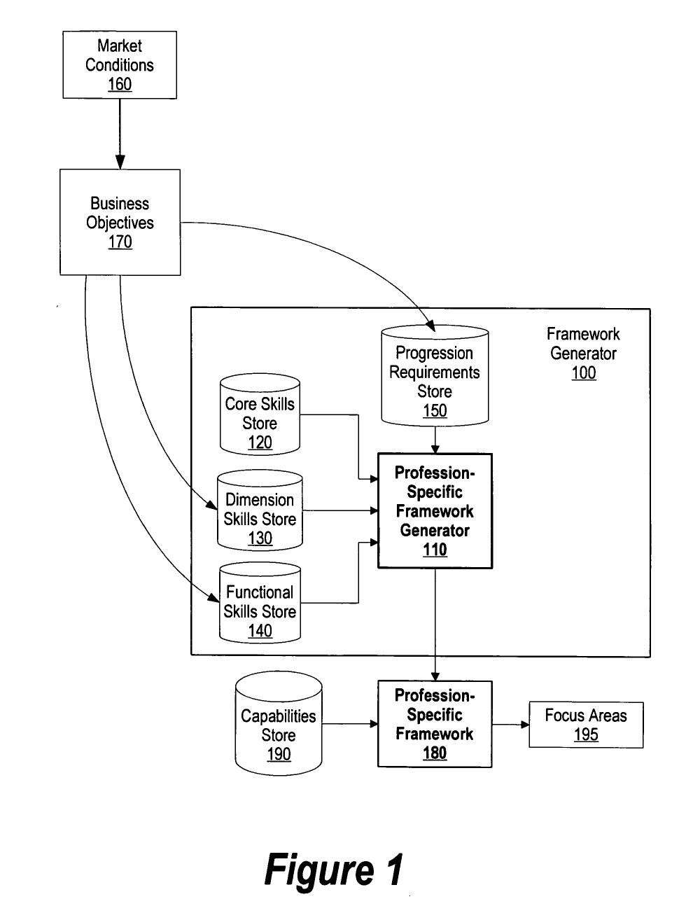

FIG. 1 is a diagram showing a framework generator generating a profession-specific framework that is based upon market conditions and business objectives. Framework generator 100 tightly aligns employee career development with an organization's business objectives (e.g. business objectives 170). It enables the development of a fluid on-demand workforce that quickly and decisively respond to changing market conditions (e.g. market conditions 160) while at the same time providing stable direction to employees by establishing core skill guidelines for nurturing a successful career.

Framework generator 100 stratifies and describes a unique set of skills that an employee requires in order to advance in his career. Additionally, framework generator 100 defines different purposes and relationships of these stratified skill sets so an employee understands when, why, and how to develop each skill to best maximize his personal knowledge development and his professional career opportunities within an organization.

An organization uses market conditions 160 to drive business objectives 170. The organization may not respond to minor fluctuations in market conditions 160 to significantly alter business objectives 170. Instead, an organization may monitor trends corresponding to market conditions 160, and adapts business objectives 170 to the changing market trends. For example, an organization may identify a new technology trend and choose to enter in to a particular market niche corresponding to the market trend. Framework generator 100 receives business objectives 170, and uses business objectives 170 to define dimension skills, functional skills, and progression requirements, each of which is located in dimension skills store 130, functional skills store 140, and progression requirements store 150, respectively. Dimensional skills are skills that are aligned with a particular profession, such as an IT architect or a consultant. Functional skills are skills that focus on a fine level of specialization within an industry, such as “oracle programming” in the IT industry.

Progression requirements are requirements that are used to rank an employee based upon his capabilities that correspond to dimensional skills and core skills. Core skills are generalized skills that are required from each employee in order to support an organization's business objectives. For example, “relationship” may be a core skill that measures an employee's ability to communicate with other employees. An organization may use business objectives 170 to drive core skills in a broader, long-term sense. Core skills are located in core skills store 120. Core skills store 120, dimension skills store 130, functional skills store 140, and progression requirements store 150 may be stored on a nonvolatile storage area, such as a computer hard drive.

Framework generator 100 includes profession-specific framework generator 110 that generates a framework for particular professions, such as an IT architect or a consultant. In one embodiment, framework generator 100 may include a business function-specific framework generator to generate frameworks that are specific to a business function, such as “package enablement.” In this example, an applications programmer and a salesperson that work with package enablement may use a similar framework to evaluate their capabilities.

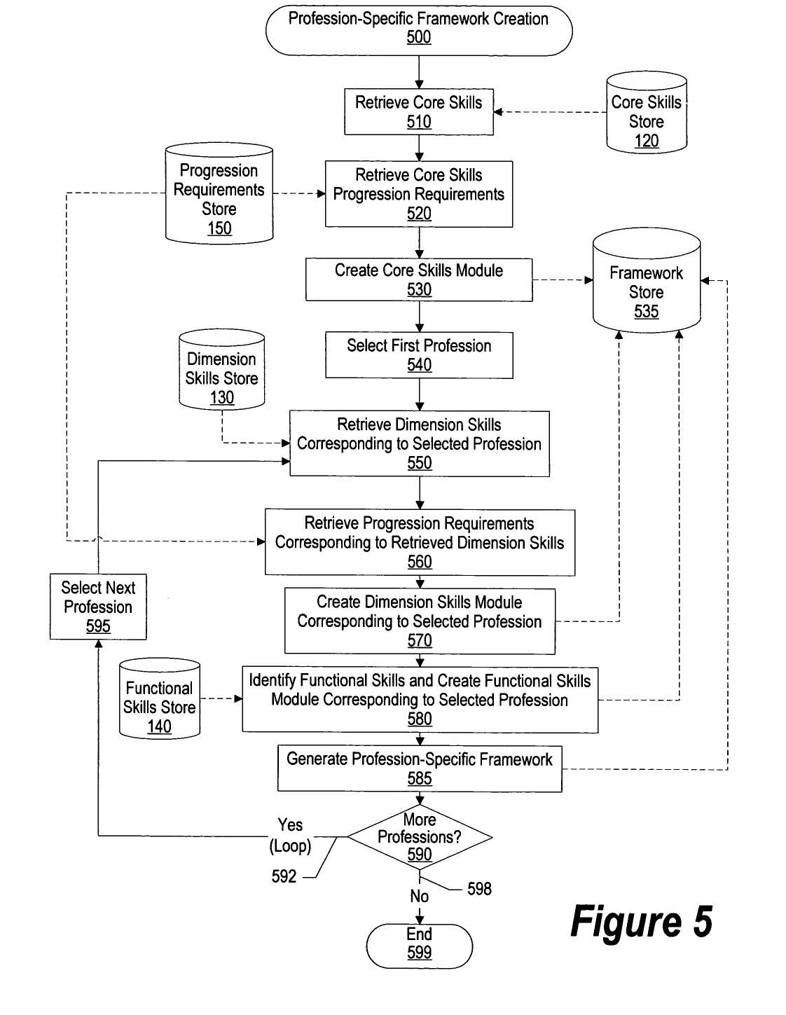

Profession-specific framework generator 110 retrieves core skills from core skills store 120 to generate a core skills module. It then retrieves dimension skills from dimension skills store 130 that correspond to a particular profession, and generates a dimension skills module. Then, profession-specific framework generator 110 retrieves functional skills from functional skills store 140 and generates a functional skills module. Finally, profession-specific framework generator 110 retrieves progression requirements that correspond to the retrieved core skills and the retrieved dimension skills, and includes the progression requirements, the core skills module, the dimension skills module, and the functional skills module in profession-specific framework 180 (see FIG. 5 and corresponding text for further details regarding framework generation).

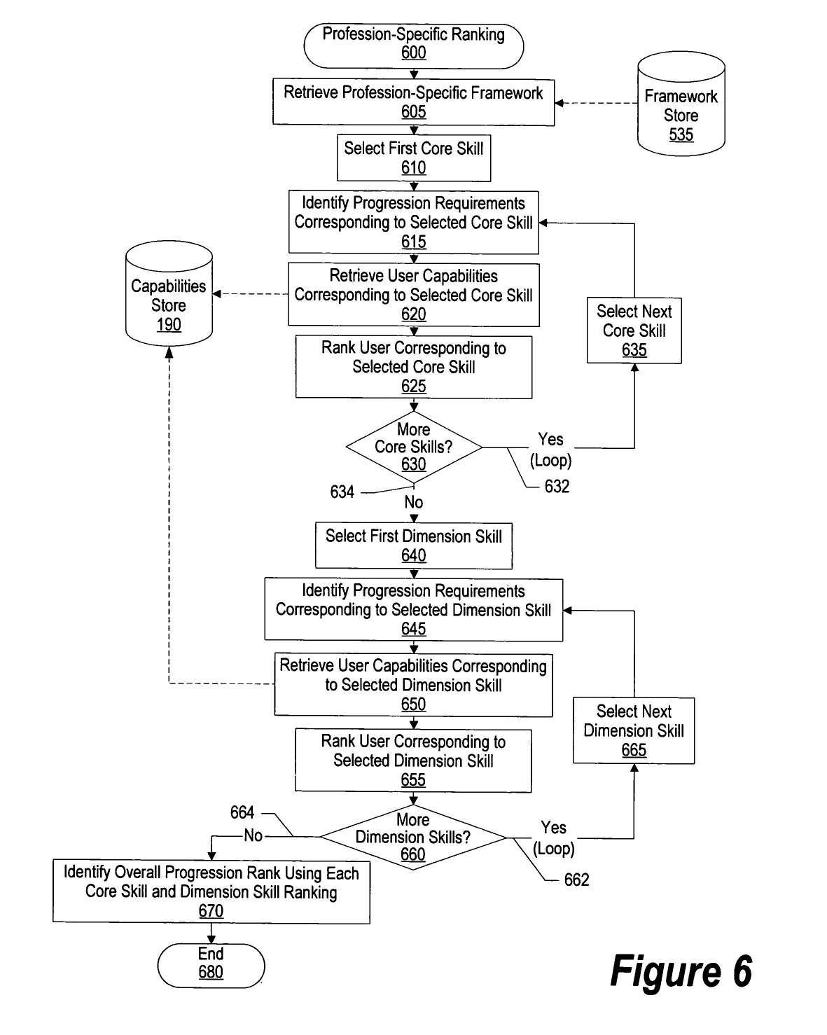

Profession-specific framework 180 retrieves user capabilities from user capabilities store 190 that corresponds to a user that is being evaluated. Profession-specific framework 180 compares the user capabilities with its progression requirements, and ranks the user for each core skill and dimension skill. Once the user is ranked for each skill, the user receives an overall ranking. The user is able to identify particular areas which to focus (e.g. focus areas 195) based upon its skill ranking in order to advance in his career (see FIG. 6 and corresponding text for further details regarding user ranking).

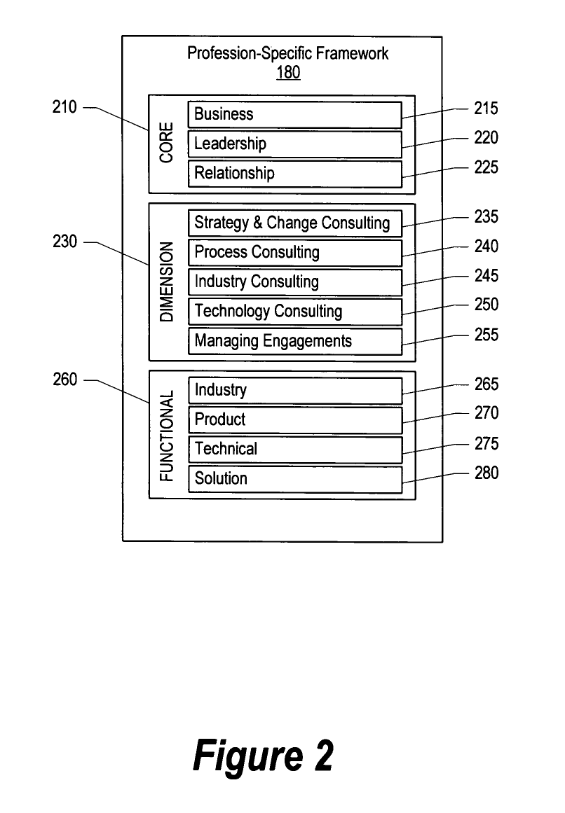

FIG. 2 is a framework diagram that shows skills that are divided into three modules. Profession-specific framework 180 was generated using a framework generator and is targeted towards a profession-specific job function. As one skilled in the art can appreciate, a framework may also be developed that is targeted towards a business function, such as package enablement. In this example, an applications programmer and a salesperson that work with package enablement may use a similar framework to evaluate their capabilities. Profession-specific framework 180 is the same as that shown in FIG. 1.

Profession-specific framework 180 includes three skill modules, which are core skills 210, dimension skills 230, and functional skills 260. Core skills 210 includes skills that are required from each user and are focused on generalized business conduct. Core skills 210 includes business 215, leadership 220, and relationship 225. Business 215 is a core skill that measures how well a user understands a business environment. Leadership 220 is a core skill that measures how well a user can lead other users. Relationship 225 is a core skill that measures how well a user communicates and presents himself to other users. For example, business skills may include understanding pricing concepts, effectively crafting business proposals, and understanding strategic business themes. Leadership skills may include professional vitality, team building, and performance management. Relationship skills may include communications, negotiations, and managing organizational change.

Dimension skills 230 includes skills that are particular to a profession, such as a consultant. Dimension skills includes strategy and change consulting 235, process consulting 240, industry consulting 245, technology consulting 250, and managing engagements 255. For example, strategy and change consulting skills may include items such as “delivered well-articulated and structured work products based on issue identification, comprehensive analysis, hypotheses and synthesis of strategy and change issues and met client specific needs”, or “conducted client interviews and co-facilitated workshops to identify needs and to determine aspects of business that support strategy”. Similarly, industry consulting skills may include items such as “achieved recognition as a subject matter expert in a strategic industry by practice area leadership through demonstrated industry capabilities and the ability to add value by creating, sharing and leveraging knowledge”.

Functional skills 260 includes skills that are required from a user for a particular specialization, such as promoting a particular product line. Functional skills 260 includes industry 265, product 270, technical 275, and solution 280. Examples of functional skills may include Java technologies, such as Javascript, or enterprise asset management skills, such as specifics corresponding to “Datastream” or “Passport.” Other functional skills sets may include groupware tools or advanced storage solutions, SAP for automotive, or financial markets for equities.

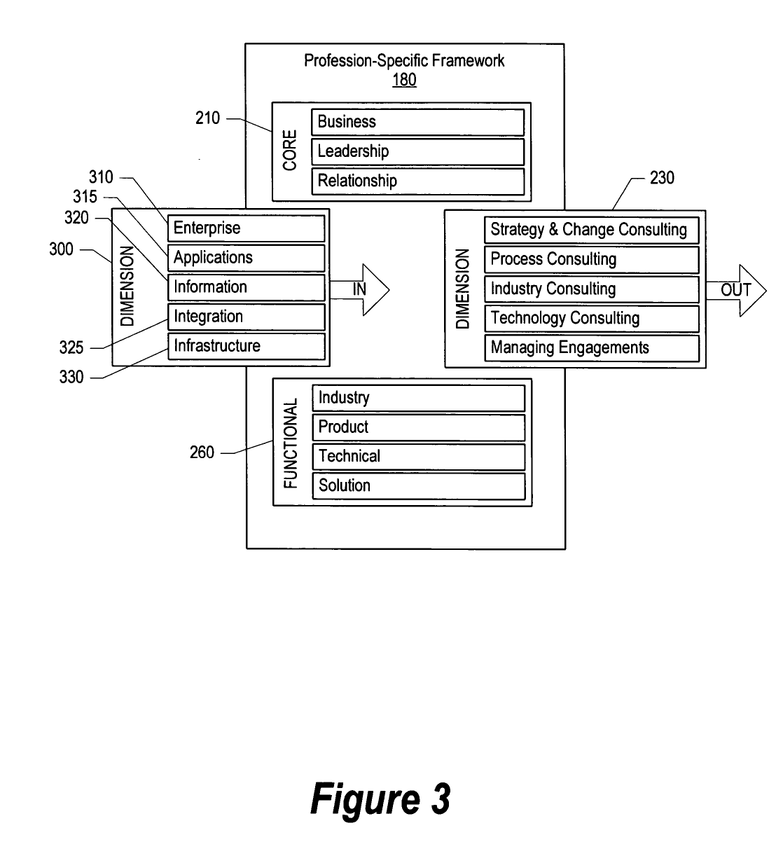

FIG. 3 is a diagram showing a profession-specific framework's modularity. The example in FIG. 3 shows that dimension skills are profession-specific. In one embodiment, the dimension skills may be business function-based skills, such as application development. In this embodiment, frameworks may be developed that are targeted towards sales, marketing, and application support.

Profession-specific framework 180 includes core skills 210, dimension skills 230, and functional skills 260, each of which are the same as that shown in FIG. 2. Dimension skills 230 is targeted towards a consultant profession. The example shown in FIG. 3 shows that dimension skills 230 is being swapped out for dimension skills 300, which is targeted towards an information technology (IT) architect profession. Dimension skills 300 includes enterprise 310, applications 315, information 320, integration 325, and infrastructure 330. For example, enterprise application skills may include items such as “in-complex client environment propose the most appropriate Enterprise Application engagement plan to align the customer's business and IT environment.” Additionally, infrastructure skills may include items such as “use a defined set of criteria to evaluate the infrastructure architecture, its components and their properties, the relationships among those components, and how they interact, so that the evaluation results are usable for other infrastructure architecture activities” (e.g., design and implementation of a significant change to the infrastructure, support for new applications).

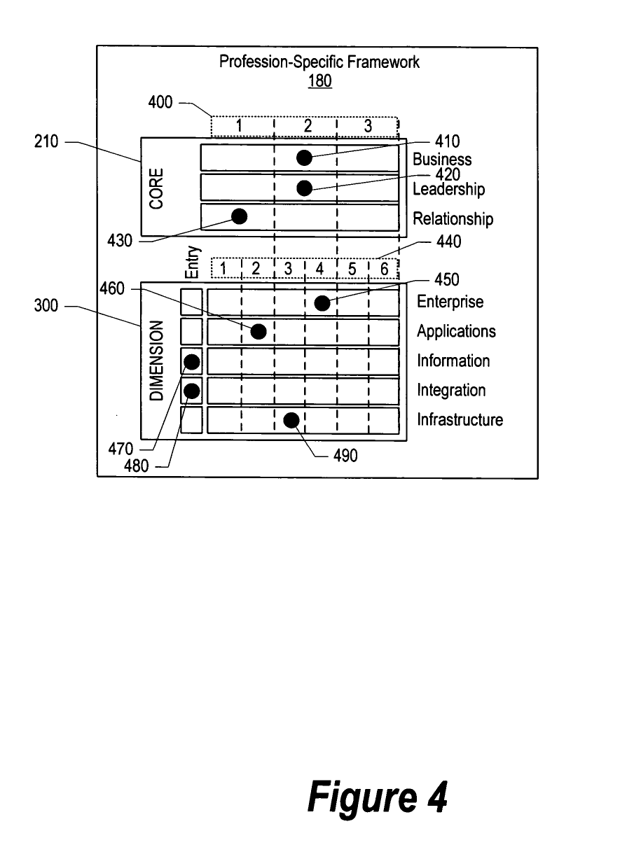

FIG. 4 is a diagram showing skill rankings for a particular user. Profession-specific framework 180 includes core skills 210 and dimension skills 300. Profession-specific framework 180, core skills 210, and dimension skills 300 are the same as that shown in FIGS. 1, 2, and 3, respectively. As illustrated in ranking bar 400, a user is given a ranking from “1” to “3” for each core skill that is included in core skill 210. If a user is given a rank of “1” for a particular core skill, the user may be considered a novice at the particular core skill. If a user is given a rank of “2” for a particular core skill, the user may be considered experienced at that particular core skill. And, if a user is given a rank of “3” for a particular core skill, the user may be considered advanced for that particular core skill. As one skilled in the art can appreciate other ranking techniques may be use to measure user capabilities.

The example in FIG. 4 shows that the user is given a rank of “2” for business (rank 410) and leadership (rank 420) core skills, and is given a rank of “1” for a relationship (rank 430) core skill. This ranking indicates that the user should focus on improving his relationship skills in order to bring them up to the level that corresponds with his other core skills.

As illustrated in ranking bar 440, a user is given a rank from “1” to “6” for each dimension skill that is included in dimension skill 300. A user may also be given a ranking of “entry” if the user does not posses minimum capabilities that correspond to a core skill. The example in FIG. 4 shows that a user is given a rank of “4” for an enterprise (rank 450) dimension skill. This is one of the user's higher dimension skills and indicates that his enterprise capability is the user's most developed skill. In addition, the example shows rankings for other dimension skills included in dimension skills module 300, such as applications (rank 460), information (rank 470), integration (rank 480), and infrastructure (rank 490). Once the user receives a ranking for each core skill and each dimension skill, the user receives an overall ranking based upon his individual skill rankings (see FIG. 6 and corresponding text for further details regarding overall ranking).

FIG. 5 is a flowchart showing steps taken in creating a profession-specific framework based upon skill sets and progression requirements. In one embodiment, a framework may be created based upon a business model or business function. For example, a framework may be created that is tailored towards a particular business function, such as package enablement. In this example, an applications programmer and a salesperson that work with package enablement may have a similar framework.

Framework creation commences at 500, whereupon processing retrieves core skills from core skills store 120 (step 510). Core skills are general skills that a business requires each employee to posses, such as a leadership skill. Core skills store 120 is the same as that shown in FIG. 1 and may be stored on a nonvolatile storage area, such as a computer hard drive.

Processing retrieves progression requirements from progression requirements store 150 that correspond to the core skills (step 520). The progression requirements are used to measure an individual's capabilities corresponding to a particular skill. The progression requirements allow an individual to identify strengths and weaknesses in his capabilities. For example, based upon progression requirements, an individual may have good business and leadership capabilities, but may have poor relationship capabilities. Processing creates a core skill module using the retrieved core skills and their corresponding progression requirements, and stores them in framework store 535 at step 530.

Processing selects a first profession to generate a profession-specific framework at step 540, such as a “consultant”. Processing retrieves dimension skills from dimension skills store 130 that correspond to the selected profession (step 550). Using the example described above, dimension skills corresponding to a “consultant” profession may be “strategy and change”, “process”, “industry”, “technology”, and “managing engagements”. Dimension skills store 130 is the same as that shown in FIG. 1 and may be stored on a nonvolatile storage area, such as a computer hard drive.

At step 560, processing retrieves progression requirements from progression requirements store 150 that corresponds to the retrieved dimension skills. Processing creates a dimension skills module to correspond to the selected profession using the retrieved dimension skills and their corresponding progression requirements, and stores the dimension skills module in framework store 535 (step 570).

At step 580, processing identifies functional skills that correspond to the selected profession. Functional skills are skills that correspond to an individual's particular specialization. For example, a functional skill for an IT architect may be “oracle programming.” Processing generates a profession-specific framework using the core skills module, the dimension skills module, and the functional skills module at step 585.

A determination is made as to whether there are more professions to create a corresponding profession-specific framework (decision 590). If there are more professions to create a corresponding profession-specific framework, decision 590 branches to “Yes” branch 592 which loops back to select (step 595) and process the next profession. This looping continues until there are no more professions to process, at which point decision 590 branches to “No” branch 598 whereupon processing ends at 599.

FIG. 6 is a flowchart showing steps taken in ranking a user using a profession-specific framework. In one embodiment, users may be ranked using a business model or business function framework, such as package development. Processing commences at 600, whereupon processing retrieves a profession-specific framework from framework store 535 (step 605). The profession-specific framework includes core skills that are generalized skills, dimension skills that are particular to a profession, and functional skills that are specialized skills that correspond to a profession. Framework store 535 is the same as that shown in FIG. 5, and may be stored on a nonvolatile storage area, such as a computer hard drive.

Processing selects a first core skill included in the profession-specific framework at step 610. At step 615, processing identifies progression requirements that correspond to the selected core skill. For example, if “relationship” is the first core skill, the core skill progression requirements may include requirements to take particular public speaking classes as well as present to an audience a particular number of times.

Processing retrieves user capabilities from user capabilities store 190 that correspond to a user and the first core skill (step 620). Using the example described above, a user may have attended a number of public speaking classes but may not yet have presented in front of an audience. User capabilities store 190 is the same as that shown in FIG. 1 and may be stored on a nonvolatile storage area, such as a computer hard drive. Processing ranks the user based upon the user's capabilities and the progression requirements (step 625). Using the example described above, processing may rank the user at “level 2” because the user has taken public speaking classes but has not presented in front of an audience.

A determination is made as to whether there is more core skills included the profession-specific framework to process (decision 630). If there are more core skills included in profession-specific framework, decision 630 branches to “Yes” branch 632 whereupon processing selects (step 635) and processes the next core skill. This looping continues until each core skill has been processed, and the user has received a core skill ranking for each core skill, at which point decision 630 branches to “No” branch 634.

Processing selects a first dimension skill that is located in the profession-specific framework at step 640. A dimension skill is particular to a profession, such as “applications” for an IT architect. At step 645, processing identifies progression requirements that correspond to the selected dimension skill. Processing retrieves user capabilities from user capabilities store 190 that correspond to a user and the first dimension skill (step 650). At step 655, processing ranks the user based upon the dimension skill progression requirements and the user's capabilities. The ranking results in a dimension rank which corresponds to the first dimension skill.

A determination is made as to whether the profession-specific framework includes more dimension skills (decision 660). If there are more dimension skills in the profession-specific framework to process, decision 660 branches to “Yes” branch 662 which loops back to select (step 665) and process the next dimension skill. This looping continues until there are no more dimension skills to process, at which point decision 660 branches to “No” branch 664.

Processing evaluates each core skill ranking and each dimension skill ranking, and determines an overall progression ranking at step 670. The overall progression ranking informs a user as to his overall value to the corporation, and also gives the user insight as to areas he should improve in order to receive a higher overall ranking. For example, a user may be an excellent consultant, but the user may not able to communicate with customers. In this example, the user receives a high “consultant” ranking but receives a low “relationship” ranking. Therefore, the user's overall progression rank is lowered due to the user's relationship ranking. The user may then choose to take action in order to improve his relationship ranking, such as attending a public speaking course. In one embodiment, overall ranking may be achieved suing an averaging approach or a weighted approach. Processing ends at 680.

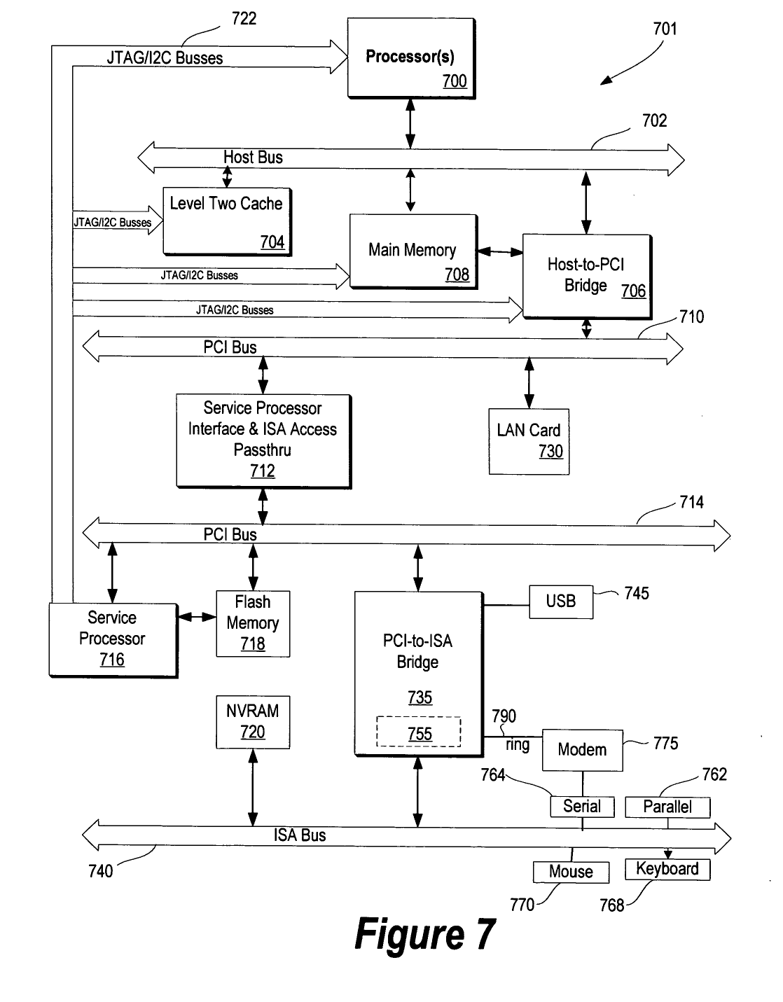

FIG. 7 illustrates information handling system 701 which is a simplified example of a computer system capable of performing the computing operations described herein. Computer system 701 includes processor 700 which is coupled to host bus 702. A level two (L2) cache memory 704 is also coupled to host bus 702. Host-to-PCI bridge 706 is coupled to main memory 708, includes cache memory and main memory control functions, and provides bus control to handle transfers among PCI bus 710, processor 700, L2 cache 704, main memory 708, and host bus 702. Main memory 708 is coupled to Host-to-PCI bridge 706 as well as host bus 702. Devices used solely by host processor(s) 700, such as LAN card 730, are coupled to PCI bus 710. Service Processor Interface and ISA Access Pass-through 712 provides an interface between PCI bus 710 and PCI bus 714. In this manner, PCI bus 714 is insulated from PCI bus 710. Devices, such as flash memory 718, are coupled to PCI bus 714. In one implementation, flash memory 718 includes BIOS code that incorporates the necessary processor executable code for a variety of low-level system functions and system boot functions.

PCI bus 714 provides an interface for a variety of devices that are shared by host processor(s) 700 and Service Processor 716 including, for example, flash memory 718. PCI-to-ISA bridge 735 provides bus control to handle transfers between PCI bus 714 and ISA bus 740, universal serial bus (USB) functionality 745, power management functionality 755, and can include other functional elements not shown, such as a real-time clock (RTC), DMA control, interrupt support, and system management bus support. Nonvolatile RAM 720 is attached to ISA Bus 740. Service Processor 716 includes JTAG and I2C busses 722 for communication with processor(s) 700 during initialization steps. JTAG/I2C busses 722 are also coupled to L2 cache 704, Host-to-PCI bridge 706, and main memory 708 providing a communications path between the processor, the Service Processor, the L2 cache, the Host-to-PCI bridge, and the main memory. Service Processor 716 also has access to system power resources for powering down information handling device 701.

Peripheral devices and input/output (I/O) devices can be attached to various interfaces (e.g., parallel interface 762, serial interface 764, keyboard interface 768, and mouse interface 770 coupled to ISA bus 740. Alternatively, many I/O devices can be accommodated by a super I/O controller (not shown) attached to ISA bus 740.

In order to attach computer system 701 to another computer system to copy files over a network, LAN card 730 is coupled to PCI bus 710. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method comprising:
retrieving one or more core skills, wherein each core skill corresponds to each of a plurality of users;
retrieving a subset of dimension skills from a plurality of dimension skills, wherein the subset of dimension skills correspond to a subset of the plurality of users;
identifying a progression requirement for each of the core skills and the subset of dimension skills;
including the retrieved core skills, the subset of dimension skills, and the identified progression requirements in a framework; and
evaluating one of the plurality of users using the framework, the evaluating resulting in an evaluated user.

2. The method of claim 1 wherein the evaluating further comprises:
retrieving a user capability, the user capability corresponding to the evaluated user;
matching the user capability with one of the progression requirements that are included in the framework; and
ranking the evaluated user in response to the matching, the ranking resulting in a skill ranking.

3. The method of claim 2 further comprising:
computing the skill ranking for each of the core skills and each of the subset of dimension skills, the computing resulting in a plurality of skill rankings; and
establishing an overall ranking based upon the plurality of skill rankings.

4. The method of claim 3 further comprising:
identifying one or more user improvement areas,
wherein the user improvement area corresponds to one of the core skill or one of the dimension skill which requires the user to improve in order to increase the user's overall ranking.

5. The method of claim 1 wherein the subset of dimension skills constitutes a first dimension skills module, the method further comprising:
selecting one or more dimension skills from the plurality of dimension skills, the selecting resulting in a second dimension skills module; and
replacing the first dimension skills module with the second dimension skills module in the framework.

6. The method of claim 1 further comprising:
identifying one or more functional skills that correspond to the subset of dimension skills; and
including the identified functional skills in the framework.

7. The method of claim 1 wherein the framework is selected from the group consisting of a profession-specific framework and a business function-specific framework.

8. An information handling system comprising:
one or more processors;
a memory accessible by the processors;
one or more nonvolatile storage devices accessible by the processors; and
a workforce evaluation tool for evaluating a workforce, the workforce evaluation tool comprising software code effective to:
retrieve one or more core skills from one of the nonvolatile storage devices, wherein each core skill corresponds to each of a plurality of users;
retrieve a subset of dimension skills from a plurality of dimension skills located in one of the nonvolatile storage devices, wherein the subset of dimension skills correspond to a subset of the plurality of users;
identify a progression requirement for each of the core skills and the subset of dimension skills;
include the retrieved core skills, the subset of dimension skills, and the identified progression requirements in a framework; and
evaluate one of the plurality of users using the framework, the evaluating resulting in an evaluated user.

9. The information handling system of claim 8 wherein the software code is further effective to:
retrieve a user capability from one of the nonvolatile storage devices, the user capability corresponding to the evaluated user;
match the user capability with one of the progression requirements that are included in the framework; and
rank the evaluated user in response to the matching, the ranking resulting in a skill ranking.

10. The information handling system of claim 9 wherein the software code is further effective to:
compute the skill ranking for each of the core skills and each of the subset of dimension skills, the computing resulting in a plurality of skill rankings; and
establish an overall ranking based upon the plurality of skill rankings.

11. The information handling system of claim 10 wherein the software code is further effective to:
identify one or more user improvement areas, wherein the user improvement area corresponds to one of the core skill or one of the dimension skill which requires the user to improve in order to increase the user's overall ranking.

12. The information handling system of claim 8 wherein the subset of dimension skills constitutes a first dimension skills module, and wherein the software code is further effective to:
select one or more dimension skills from the plurality of dimension skills, the selecting resulting in a second dimension skills module; and
replace the first dimension skills module with the second dimension skills module in the framework.

13. The information handling system of claim 8 wherein the software code is further effective to:
identify one or more functional skills that correspond to the subset of dimension skills; and
include the identified functional skills in the framework.

14. A program product comprising:
computer operable medium having computer program code, the computer program code being effective to:
retrieve one or more core skills, wherein each core skill corresponds to each of a plurality of users;
retrieve a subset of dimension skills from a plurality of dimension skills, wherein the subset of dimension skills correspond to a subset of the plurality of users;
identify a progression requirement for each of the core skills and the subset of dimension skills;
include the retrieved core skills, the subset of dimension skills, and the identified progression requirements in a framework; and
evaluate one of the plurality of users using the framework, the evaluating resulting in an evaluated user.

15. The program product of claim 14 wherein the computer program code is further effective to:
retrieve a user capability, the user capability corresponding to the evaluated user;
match the user capability with one of the progression requirements that are included in the framework; and
rank the evaluated user in response to the matching, the ranking resulting in a skill ranking.

16. The program product of claim 15 wherein the computer program code is further effective to:
compute the skill ranking for each of the core skills and each of the subset of dimension skills, the computing resulting in a plurality of skill rankings; and
establish an overall ranking based upon the plurality of skill rankings.

17. The program product of claim 16 wherein the computer program code is further effective to:
identify one or more user improvement areas, wherein the user improvement area corresponds to one of the core skill or one of the dimension skill which requires the user to improve in order to increase the user's overall ranking.

18. The program product of claim 14 wherein the subset of dimension skills constitutes a first dimension skills module, and wherein the computer program code is further effective to:
select one or more dimension skills from the plurality of dimension skills, the selecting resulting in a second dimension skills module; and
replace the first dimension skills module with the second dimension skills module in the framework.

19. The program product of claim 14 wherein the computer program code is further effective to:
identify one or more functional skills that correspond to the subset of dimension skills; and
include the identified functional skills in the framework.

20. The program product of claim 14 wherein the framework is selected from the group consisting of a profession-specific framework and a business function-specific framework.
